(19) United States
(12) Patent Application Publication
(10) Pub. No.: US 2026/0249809 A1
(43) Pub. Date: Aug. 27, 2026

(54) SEATBELT RETRACTOR AND VEHICLE SEAT

(71) Applicant: AUTOLIV DEVELOPMENT AB, Vargarda (SE)

(72) Inventors: Arndt SÖHNCHEN, Hamburg (DE); Alexandru CIRSTEA, Elmshorn (DE); Günter CLUTE, Elmshorn (DE); Antto-Christian GLAESSER, Mömbris (DE); Jens EHLERS, Horst (DE); Hans-Jörg LANGHOFF, Bönningstedt (DE); Ronald JABUSCH, Elmshorn (DE)

(21) Appl. No.: 19/159,218

(22) PCT Filed: Feb. 26, 2024
(86) PCT No.: PCT/EP2024/054739

§ 371 Date: Aug. 22, 2025

(30) Foreign Application Priority Data
Feb. 27, 2023 (DE) 10 2023 104 728.0

(51) Int. Cl. B60R 22/34; B60R 22/26

(52) U.S. Cl. CPC B60R 22/34; B60R 22/26; B60R 2022/3402

(57) ABSTRACT

The invention relates to a seatbelt retractor for attachment in and/or on a backrest of a vehicle seat, wherein the seatbelt retractor has a housing in which a seatbelt shaft is mounted so as to be rotatable about an axis of rotation, around which seatbelt shaft a seatbelt of the seatbelt retractor can be wound, wherein the seatbelt is guided out of the seatbelt retractor through an outlet opening. Two attachment arms, which project radially in relation to the axis of rotation of the seatbelt shaft and are spaced apart from one another are provided on the housing for attaching the seatbelt retractor in or on the backrest of the vehicle seat and are designed for pivotable attachment to the backrest.

The present invention relates to a seatbelt retractor having the features of the preamble of claim 1 and to a vehicle seat having the features of the preamble of claim 11.

Restraint devices for motor vehicles comprise not only airbags but also seatbelt devices, which directly restrain the occupant via a seatbelt. The seatbelt device can be designed as a 3-point belt, for example. In this case, one end of the seatbelt can be wound onto a belt shaft of a seatbelt retractor that can be locked in the pull-out direction, and the other end is secured to the vehicle via an end fitting. Furthermore, the seatbelt has a belt tongue which can be locked in a belt buckle secured to the vehicle and which, in the locked position, divides the belt webbing of the seatbelt into a diagonal belt portion crossing the occupant's chest and a lap belt portion crossing the occupant's pelvis. If the seatbelt device is designed as a 2-point belt or a 4-point belt, the free ends can instead also be directly locked in a belt buckle secured to the vehicle by means of a belt tongue.

The restraint forces to be applied in the event of an accident are then transmitted from the seatbelt, via the connecting points attached to the vehicle, i.e., the seatbelt retractor, the end fitting and/or the belt buckle, and into the vehicle structure so that these parts themselves and the manner in which they are secured to the vehicle structure must be designed to be correspondingly load-bearing. Furthermore, it may be necessary for the seatbelt to be deflected again as it passes out of the seatbelt shaft of the seatbelt retractor so that it is fed at an angle that is advantageous for restraining the occupant. The same problem arises if the seatbelt retractor is to be secured to a specific point for space reasons, and the seatbelt has to be fed over a longer distance before it is deflected and guided to the occupant.

From this point of view, seat-integrated seatbelt devices, such as those provided in vehicle seats of convertibles, rotating seats or bench seats, pose a particular problem. The problem with such seat-integrated seatbelt devices is the very limited space available in the vehicle seat. In addition, the restraining forces from the seatbelt retractor must be transmitted to the vehicle seat and therefore correspondingly dimensionally stable connecting points have to be provided on the vehicle seat, which complicates the possible mechanical connection of a seatbelt retractor. This applies in particular to vehicle seats that do not have a base frame made of steel, or to vehicle seats that are designed as bench seats, i.e., for example, 2 or 3 seats arranged next to each other.

Against this background, the object of the invention is to provide a seatbelt retractor for a vehicle seat and a vehicle seat having such a seatbelt retractor, which enables improved seating comfort for the occupant.

In order to achieve the object, a seatbelt retractor having the features of claim 1 and a vehicle seat having the features of claim 11 are proposed. Further preferred developments of the invention can be taken from the dependent claims, the figures, and the associated description.

According to the basic idea of the invention, a seatbelt retractor having the features of the preamble of claim 1 is proposed, in which two attachment arms projecting radially with respect to the axis of rotation of the seatbelt shaft and spaced apart from one another are provided on the housing for attaching the seatbelt retractor in or on the backrest of the vehicle seat, and are designed for pivotable attachment to the backrest.

The provided attachment arms, which are designed for a pivotable attachment of the seatbelt retractor, allow the seatbelt retractor to perform at least slight pivoting movements relative to the backrest, so that the occupant can individually adjust the orientation of the seatbelt retractor relative to or in the backrest in order to improve seating comfort. This allows the occupant to adjust the orientation of the seatbelt retractor to take into account his or her body height or an individual current seating position. The occupant can pivot the seatbelt retractor towards himself/herself for improved neck support, or pivot it into the plane of the backrest to create a straight contact surface for the backrest, for example, when the backrest is pivoted back.

It is further proposed that the attachment arms are pivotably mounted about a pivot axis running parallel to the axis of rotation of the seatbelt shaft. Due to the proposed orientation of the pivot axis of the pivotable attachment, the seatbelt pulled off the seatbelt shaft is only displaced vertically when the seatbelt retractor is pivoted in relation to the rotation axis of the seatbelt shaft, while maintaining its angular orientation to the seatbelt retractor.

It is further proposed that the attachment arms are arranged at the end sides of the housing with respect to the longitudinal direction of the axis of rotation of the seatbelt shaft. Due to the proposed arrangement of the attachment arms, they have a maximum distance from each other, and the seatbelt retractor is thus arranged with its housing between the attachment arms. This means that the seatbelt retractor receives maximum support on the backrest via the attachment arms and is supported by the attachment arms across its entire width.

It is further proposed that the pivotable attachment of the attachment arms is formed by a bearing opening in each of the attachment arms, and that the bearing openings are arranged coaxially with respect to one another. The coaxially arranged bearing openings prevent the seatbelt retractor from twisting, particularly in the region of the attachment arms and in the region of the housing, when the seatbelt retractor is pivoted, thereby creating additional material stresses.

It is further proposed that the attachment arms are designed as rigid U-profile parts. The proposed design of the attachment arms allows them to be very dimensionally stable, particularly against external bending moments, while at the same time having a low dead weight.

It is further proposed that the U-profile parts each have a base plate and two legs extending from the base plate to one side and parallel to each other, and that the attachment arms are oriented such that the legs of one attachment arm are each oriented in the direction of the other attachment arm.

It is further proposed that the legs are connected to each other via a partially annular web surrounding the bearing opening. The partially annular web also stiffens the attachment arms in the region of the bearing opening. Furthermore, the partially annular web creates a homogeneous shape of the attachment arms, even in the transition to the bearing opening.

It is further proposed that the housing has two receptacles spaced apart from one another and directed radially with respect to the axis of rotation of the seatbelt shaft, in which the attachment arms are fixed. The attachment arms and the housing are therefore different parts, which are connected to each other via the receptacles to form the overall shape of the seatbelt retractor. The shapes of the housing and the attachment arms can be individually designed in terms of their function, e.g., as a multi-formed part. The receptacles and their orientation enable individual attachment of the attachment arms to the housing according to the predetermined orientation of the attachment arms.

It is further proposed that the attachment arms taper conically radially outwards from the housing. The proposed design of the attachment arms allows the seatbelt retractor to be designed with a wider or thicker housing and to be attached to a narrower structure, e.g., a narrow longitudinal strut of the backrest.

It is further proposed that the seatbelt retractor be attached via the attachment arms at a distance of 20 to 40 cm from the axis of rotation of the seatbelt shaft. Due to the proposed distance of 20 to 40 cm, the seatbelt retractor with its housing can be pivoted even at small pivoting angles through an adjustment range that is clearly perceptible to the occupant.

Furthermore, a vehicle seat having a backrest and a seatbelt retractor attached thereto according to any of claims 1 to 10 is proposed to achieve the object, wherein the backrest has at least two longitudinal struts spaced apart from one another and arranged parallel to one another, and the seatbelt retractor is pivotably attached to the longitudinal struts by means of the attachment arms. The seatbelt retractor, together with the attachment arms, essentially forms an extension of the longitudinal struts of the backrest, while the housing of the seatbelt retractor connects the longitudinal struts extended via the attachment arms to form a frame that is closed at least in this region. In this case, the seatbelt retractor together with its housing forms the upper edge portion of the backrest structure.

It is further proposed that one of the longitudinal struts is arranged at one of the edge sides of the backrest and that the other longitudinal strut is arranged at the opposite edge side of the backrest. The longitudinal struts and the seatbelt retractor, which connect the longitudinal struts via the attachment arms, thus form the outer frame of the backrest structure. Due to the pivotable attachment of the seatbelt retractor realized via the attachment arms and the proposed design of the backrest structure with the integrated seatbelt retractor, the pivotably attached seatbelt retractor itself forms a pivotable part of the backrest, which the occupant can use to actively adjust the seat geometry and thus increase seating comfort.

It is further proposed that the seatbelt retractor be arranged with the axis of rotation of the seatbelt shaft parallel to the upper edge side of the backrest. Due to the proposed orientation of the seatbelt retractor, the extension plane of the seat belt is preferably parallel to the upper edge of the backrest. If the seatbelt shaft in the seatbelt retractor is blocked by a radial blocking device when a predetermined pull-out acceleration of the seatbelt is exceeded or when a predetermined vehicle deceleration is exceeded, reaction forces acting perpendicular to the axis of rotation are generated in the backrest structure when the seatbelt shaft is blocked, which reaction forces are directed in the radial direction perpendicular to the axis of rotation due to the proposed orientation of the axis of rotation, and thus in the direction of the longitudinal struts of the backrest structure oriented perpendicular to the upper edge side of the backrest. This makes it particularly simple for the reaction forces to be absorbed by the longitudinal struts and transferred into the vehicle structure.

The invention is explained below using preferred embodiments with reference to the accompanying figures. In the figures:

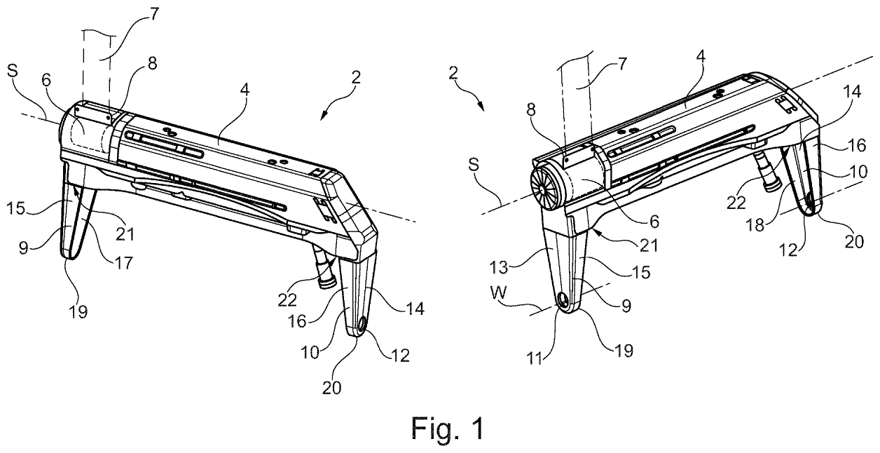

FIG. 1: is a seatbelt retractor according to the invention in two different views; and

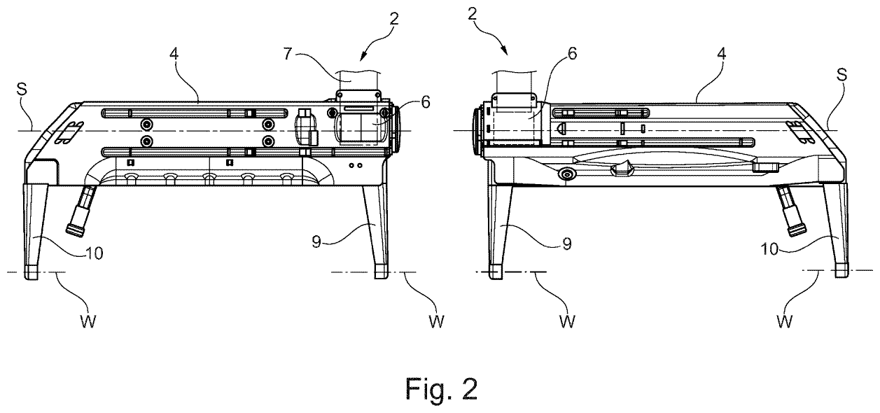

FIG. 2: is the seatbelt retractor of FIG. 1 in a front view and in a rear view; and

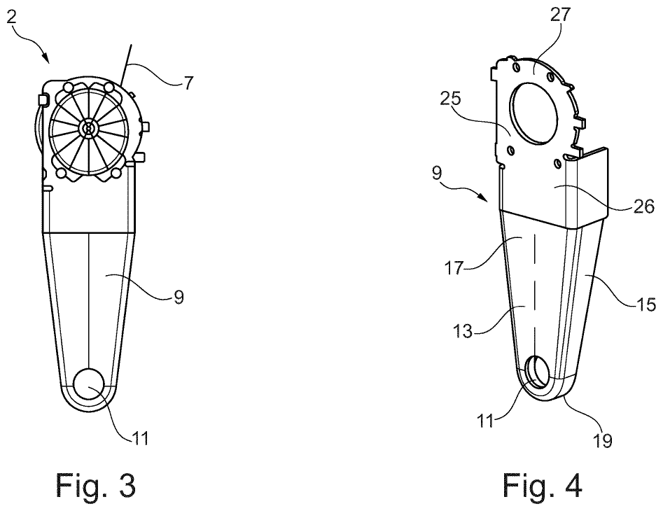

FIG. 3: is the seatbelt retractor of FIG. 1 in a side view; and

FIG. 4: is an attachment arm with a frame leg as a separate part; and

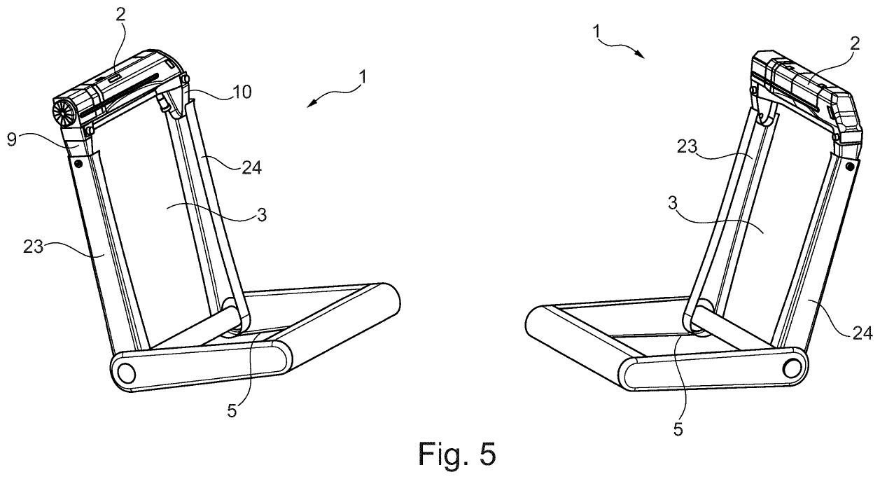

FIG. 5: is a seat frame of a vehicle seat according to the invention in two different views; and

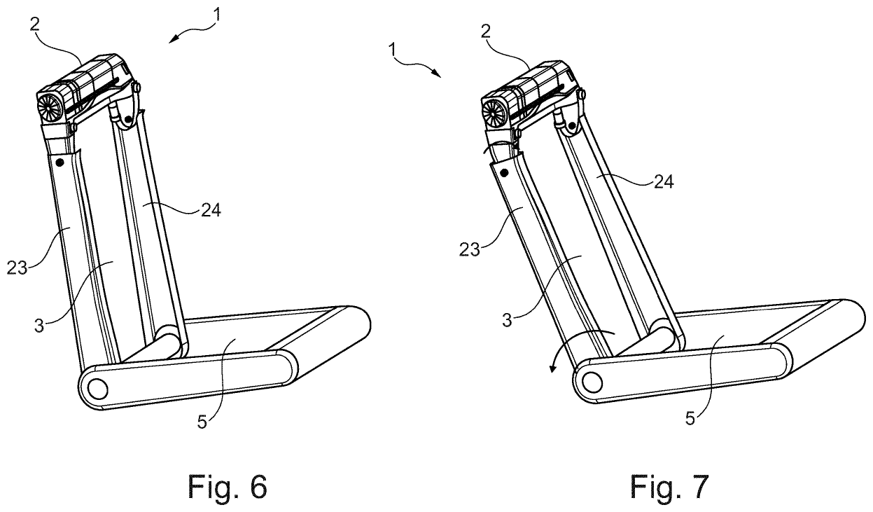

FIG. 6: is the vehicle seat with the seatbelt retractor in an upright position of the backrest and of the seatbelt retractor; and

FIG. 7: is the vehicle seat with the seatbelt retractor in a backwards-pivoted position of the backrest and a forward-pivoted position of the seatbelt retractor.

FIGS. 1 and 2 show a seatbelt retractor 2 according to the invention in different views. The seatbelt retractor 2 has a housing 4, which is composed of multiple elongated profile parts that form an elongated cavity in which a seatbelt shaft 6 is rotatably mounted. In addition to the rotatably mounted seatbelt shaft 6, additional assemblies, such as a force limiting device, a reversible belt tensioner, an irreversible belt tensioner including associated sensors, actuators, bearing plates, control units, and the like, may be provided in the housing 4. The housing 4 has an outlet opening 8 through which a seatbelt 7, which can be wound onto the seatbelt shaft 6, is guided out to restrain an occupant. The seatbelt shaft 6 is mounted so as to be rotatable about an axis of rotation S, which is oriented in the longitudinal extension of the housing 4.

The housing 4 has, at each of its ends, a receptacle 21 and 22 extending radially outward with respect to the axis of rotation of the seatbelt shaft, in each of which an attachment arm 9 and 10, respectively, extending radially outward in the same direction, is fixed.

The attachment arms 9 and 10 each have a circular bearing opening 11 and 12 at their radially outer ends, which enable a pivotable attachment to a vehicle seat 1 described in more detail below. The bearing openings 11 and 12 are flush and coaxial with each other, and thus define a pivot axis W of the seatbelt retractor 2 in its fastened position relative to the vehicle seat 1.

The attachment arms 9 and 10 are shaped so as to taper conically radially outward in the direction of the bearing openings 11 and 12. In cross section, the attachment arms 9 and 10 are each U-shaped, with a base plate 13 and 14 and two legs 15, 17 and 16, 18 extending in the axial direction on the same side. The bearing openings 11 and 12 are each arranged in the base plate 13 and 14 of the attachment arms 9 and 10, and are each surrounded by a partially annular web 19 and 20, which connects the opposite legs 15 and 17, as well as 16 and 18, of the attachment arms 9 and 10 to one another. The attachment arms 9 and 10 are arranged such that the legs 15, 17 and 16, 18 extending therefrom in the axial direction are each directed toward the opposite attachment arm 9 and 10. Thus, the attachment arms 9 and 10 each form a hollow profile, which is arranged such that the open cavity faces the other attachment arm 9 and 10. Overall, this results in a particularly torsion-resistant overall structure of the seatbelt retractor 2 and a particularly torsion-resistant attachment of the seatbelt retractor 2 to the vehicle seat 1.

In FIG. 3, the seatbelt retractor 2 can be seen from the side in the direction of view of the attachment arm 9, while in FIG. 4, the attachment arm 9 can be seen with a holding part 25. The attachment arm 9 is encompassed, at its end facing away from the bearing opening 11, by a holding portion 26 of the holding part 25. The holding part 25 further comprises a bearing plate 27, which serves to support the seatbelt shaft 6 and is firmly clamped between the parts of the housing 4 in the mounted position of the seatbelt retractor 2. The holding part 25 is thus a part of the housing 4 and, together with the holding portion 26, forms the radially outwardly open receptacle 21 for the attachment arm 9 on the housing 4. The bearing plate 27 can be reinforced and additionally strengthened by an additional reinforcing plate to support the seatbelt shaft 6 in order to absorb the bearing forces and restraining forces occurring in the event of an accident. The same applies to a second bearing plate of the seatbelt shaft 6, not shown, which is located opposite the bearing plate 27 in the seatbelt retractor 2 and forms the second bearing for the seatbelt shaft 6. The reinforcing plate can be designed as a closed profile with two legs, which stiffen one or both bearing plates with the legs. This allows the seatbelt retractor 2 to be deliberately stiffened in the region of the seatbelt shaft 6 and its bearing, in order to absorb the bearing and restraining forces acting unilaterally on the seatbelt retractor 2 in the region of the seatbelt shaft 6 in the event of an accident.

In FIG. 5, a vehicle seat 1 according to the invention, with a seatbelt retractor 2 according to the invention attached thereto, can be seen in various views. The vehicle seat 1 is shown only with its seat structure, which is then provided with appropriate padding to produce the complete vehicle seat 1.

The vehicle seat 1 has a seat surface 5 and a backrest 3, which can be pivoted relative to the seat surface 5 in a known manner. The backrest 3 comprises two longitudinal struts 23 and 24, which are oriented parallel to each other and form the lateral edges of the backrest structure. The seatbelt retractor 2 is pivotably attached to the upper ends of the longitudinal struts 23 and 24 via the bearing openings 11 and 12 of its attachment arms 9 and 10. The seatbelt retractor 2 thereby connects the longitudinal struts 23 and 24 to form a frame which is closed at the top, wherein the seatbelt retractor 2 is arranged with the axis of rotation of the seatbelt shaft parallel to the upper edge of the backrest 3, or itself forms the upper edge of the backrest structure.

FIG. 6 shows the vehicle seat 1 with an upright backrest 3 and a non-pivoted seatbelt retractor 2, so that the seatbelt retractor 2, together with the longitudinal struts 23 and 24, forms a planar and flat backrest structure of the backrest 3. In FIG. 7, the same vehicle seat 1 can be seen with the backrest 3 pivoted backwards in the direction of the arrow, while the seatbelt retractor 2 is pivoted forward in the direction of the arrow, i.e., in the direction of the occupant, for example, to improve neck support for the occupant. Due to its pivotable mounting on the longitudinal struts 23 and 24, the seatbelt retractor 2 forms an additional adjustment element in the backrest 3, so that the backrest can be adjusted together with the seatbelt retractor 2 by the occupant to achieve an improved comfort position.

On one or both of the attachment arms 9 and 10, or also on one or both of the longitudinal struts 23 and 24, a releasable blocking device can additionally be provided, which blocks the position of the seatbelt retractor 2 after adjustment and can be released by the occupant before adjustment. Alternatively, the seatbelt retractor 2 can also be pivotable relative to the longitudinal struts 23 and 24 with corresponding resistance, and an acceleration-sensitive blocking device can be provided which blocks the pivoting of the seatbelt retractor 2 in the backrest 3 in the event of an accident, so that pivoting of the seatbelt retractor 2 is avoided in the event of an accident and the occupant is restrained in the known manner via the blocked seatbelt 7 in the event of an accident.

1. A seatbelt retractor for attachment in and/or on a backrest of a vehicle seat, wherein the seatbelt retractor has a housing in which a seatbelt shaft is mounted so as to be rotatable about an axis of rotation, around which seatbelt shaft a seatbelt of the seatbelt retractor can be wound, wherein the seatbelt is guided out of the seatbelt retractor through an outlet opening, wherein two attachment arms which project radially with respect to the axis of rotation of the seatbelt shaft and are spaced apart from one another are provided on the housing for attaching the seatbelt retractor in or on the backrest of the vehicle seat, and are designed for pivotable attachment to the backrest.

2. The seatbelt retractor according to claim 1, wherein the attachment arms are pivotably fastened about a pivot axis extending in parallel with the axis of rotation of the seatbelt shaft.

3. The seatbelt retractor according to claim 1, wherein the attachment arms are arranged at the end sides of the housing in relation to the longitudinal direction of the axis of rotation of the seatbelt shaft.

4. The seatbelt retractor according to claim 1, wherein the pivotable fastening of the attachment arms is formed in each case by a bearing opening in the attachment arms, and that the bearing openings are arranged coaxially with respect to one another.

5. The seatbelt retractor according to claim 1, wherein the attachment arms are designed as dimensionally stable U-profile parts.

6. The seatbelt retractor according to claim 5, wherein the U-profile parts each have a base plate and two legs extending from the base plate on one side and parallel to one another, and that the attachment arms are oriented such that the legs of one attachment arm are each oriented in the direction of the other attachment arm.

7. The seatbelt retractor according to claim 4, wherein the legs are interconnected via a partially annular web comprising the bearing opening.

8. The seatbelt retractor according to claim 1, wherein the housing has two receptacles spaced apart from one another and oriented radially with respect to the axis of rotation of the seatbelt shaft, in which the attachment arms are fixed.

9. The seatbelt retractor according to claim 1, any wherein the attachment arms taper conically radially outwards starting from the housing.

10. The seatbelt retractor according to claim 1, wherein the seatbelt retractor is fastened by means of the attachment arms at a distance of 20 to 40 cm from the axis of rotation of the seatbelt shaft.

11. A vehicle seat having a backrest and a seatbelt retractor fastened thereto according to claim 1, wherein the backrest has at least two longitudinal struts spaced apart from one another and arranged parallel to one another, and that the seatbelt retractor is pivotably attached to the longitudinal struts by means of the attachment arms.

12. The vehicle seat according to claim 11, wherein one of the longitudinal struts is arranged at one edge side of the backrest, and the other longitudinal strut is arranged at the opposite edge side of the backrest.

13. The vehicle seat according to claim 11, wherein the seatbelt retractor is arranged, with the axis of rotation of the seatbelt shaft, parallel to an upper edge side of the backrest.

14. The seatbelt retractor according to claim 2, wherein the attachment arms are arranged at the end sides of the housing in relation to the longitudinal direction of the axis of rotation of the seatbelt shaft.

15. The seatbelt retractor according to claim 2, wherein the pivotable fastening of the attachment arms is formed in each case by a bearing opening in the attachment arms, and that the bearing openings are arranged coaxially with respect to one another.

16. The seatbelt retractor according to claim 6, wherein the legs are interconnected via a partially annular web comprising the bearing opening.

17. The vehicle seat according to claim 12, wherein the seatbelt retractor is arranged, with the axis of rotation of the seatbelt shaft, parallel to an upper edge side of the backrest.
